(19) United States
(12) Patent Application Publication
(10) Pub. No.: US 2021/0207815 A1
(43) Pub. Date: Jul. 8, 2021

(54) ELECTRIC HEATING MAT

(71) Applicant: THÜRINGISCHES INSTITUT FÜR TEXTIL- UND KUNSTSTOFF-FORSCHUNG E.V., Rudolstadt (DE)

(72) Inventors: Mario SCHRÖDNER, Rudolstadt (DE); Hannes SCHACHE, Rudolstadt (DE); Lajos SZABÓ, Rudolstadt (DE); Marcel EHRHARDT, Schmorda (DE)

(73) Assignee: THÜRINGISCHES INSTITUT FÜR TEXTIL- UND KUNSTSTOFF-FORSCHUNG E.V., Rudolstadt (DE)

(21) Appl. No.: 17/143,308

(22) Filed: Jan. 7, 2021

(30) Foreign Application Priority Data
Jan. 8, 2020 (DE) 10 2020 100 226.2

(51) Int. Cl. F24D 13/02; H05B 3/14; H05B 3/03; H05B 3/34; H05B 1/02

(52) U.S. Cl. CPC F24D 13/022; H05B 3/146; H05B 3/03; H05B 3/34; H05B 2203/01; H05B 2203/016; H05B 2214/04; H05B 2203/02; H05B 1/0202

(57) ABSTRACT

The invention relates to an electric surface heater, or heating mat, based on an electrically conductive polymer foil or a conductive polymer foam that only heats locally where persons, animals or objects are positioned on the mat. Energy can thereby be saved in comparison with a full-area heater. Ideally, this local heat generation functions without any external electronic control or regulation.

### CROSS-REFERENCE TO RELATED APPLICATIONS

This application claims priority to German Patent Application 10 2020 100 226.2 filed Jan. 8, 2020, which is hereby in-corporated herein by reference in its entirety.

### FIELD OF THE INVENTION

The invention relates to an electric surface heater or heating mat based on an electrically conductive polymer foil or a conductive polymer foam that only heats locally where persons, animals or objects are positioned on the mat. Energy can thereby be saved in comparison with a full-area heater. Ideally, this local heat generation functions without any external electronic control or regulation.

### BACKGROUND OF THE INVENTION

Electric surface heaters have many applications, inter alia as wall heaters, floor heaters, mirror heaters, terrarium heaters, waterbed heaters, heatable foot mats and many more others. Whereas, for example, a large-area heat output is desired for heating rooms, in the case of heatable foot mats or heated blankets for domestic pets such as dogs, the heat is only required where there is direct contact.

Known electric surface heating systems generate the heat by converting electrical energy (Joule heat). They consist, for example, of conductive plastics that are contacted over their full area or partially by electrodes that can also be implemented as conductive tracks. Alternatively, metal conductive tracks on the heating surface, created through etching or pressing on an insulating carrier material, can themselves be used for resistive heating.

A common feature of all these electric surface heaters is that the local flow of current, and thereby the local heat development, is definitively fixed by the position and fastening of the electrodes. A locally selective control is only then possible if individual sectors of the heating surface are actively controlled.

An alternative is disclosed by the patent JPH0624768, which describes a partial and selective supply of current by means of a pressure-sensitive resistor. A disadvantage of this invention is that multiple pressure sensors must be implemented, depending on the desired local resolution. This disadvantage is overcome in the patent document JPH09245937 in that the electrically conductive heating layer is itself implemented in a pressure-sensitive manner, so that electrical heating is only generated at locations where a force or pressure acts. A disadvantage of this solution is, however, that a residual current flows even in the absence of a load due to the finite resistance that is still present, as a result of which a small quantity of energy is permanently consumed. This disadvantage too is overcome with the present invention, since no idle current flows in the unloaded case. In the sense of this invention, no idle current means that the magnitude of the current is less than 1 mA.

### SUMMARY OF ADVANTAGEOUS EMBODIMENTS OF THE INVENTION

The object of the invention is to disclose a technical solution for an electric surface heater, also referred to herein as a heating mat, to which an electric voltage has been applied. The basis of the technical solution is an electrically conductive plastic, such as an electrically conductive polymer foil (which may also be referred to as a film) or an electrically conductive polymer foam, which only generates local heating at locations where persons, animals or objects are located on the surface of the heater or heating mat, and where no current flows in the unloaded state, i.e. the unloaded portions of the surface heater or heating mat. Heat energy can be reduced thereby. Neither sensors nor electrical controllers are required for the technical solution.

### BRIEF DESCRIPTION OF THE DRAWINGS

FIG. 1 is a schematic cross sectional view of an exemplary inventive heating mat;

FIG. 2 is a schematic perspective view of an exemplary inventive heating mat; and

FIG. 3 is a thermograph of footprints on an exemplary inventive heating mat.

### DETAILED DESCRIPTION OF ADVANTAGEOUS EMBODIMENTS OF THE INVENTION

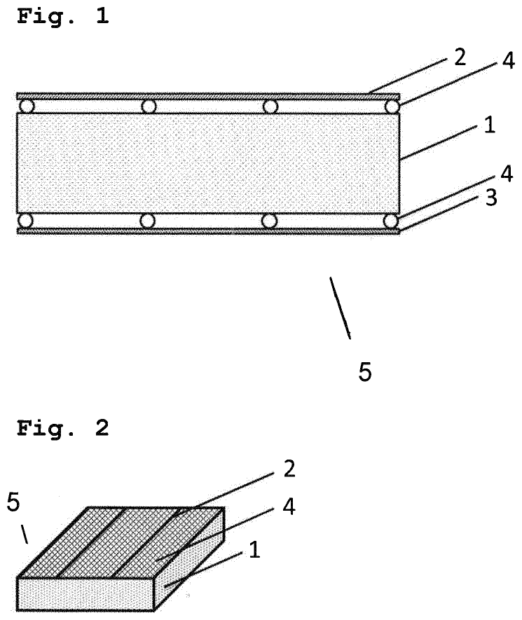

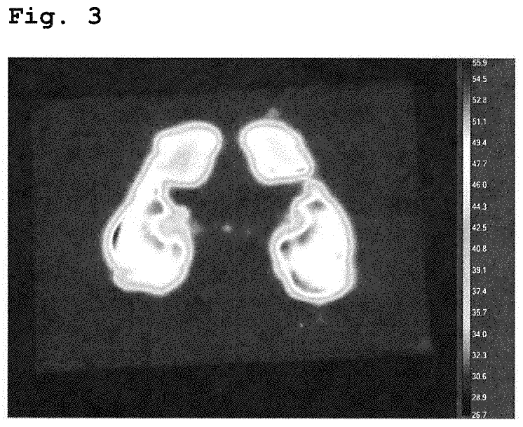

Concretely, the object is achieved by a heating mat (5), to which an electric voltage has been applied, that contains a heating body comprising or consisting of electrically conductive plastic (1) which is reversibly contacted by an upper electrode (2) and lower electrode (3), present on the upper and lower sides of the conductive plastic, respectively. Spacers (4) of an electrically non-conductive material are also located on the upper side and/or lower side of the electrically conductive plastic (1), specifically disposed between the electrically conductive plastic (1) and the electrodes (2),(3) (see FIG. 1 and FIG. 2). As a result of the spacers (4) there is no materially-locked or friction-locked contact between the electrodes (2), (3) and the electrically conductive plastic (1) in the absence of pressure. Only as a result of increased pressure following a local loading on the heating mat surface is a close contact between the electrodes (2), (3) and the electrically conductive plastic (1) of the heating body established, thereby allowing current to flow and generate heat in the region of increased pressure.

The electrically conductive plastic (1) can either be an intrinsically conductive plastic or a plastic that has been made conductive through the inclusion of additives.

Doped poly-3,4-ethylenedioxythiophene, polyaniline, polypyrrole or polythiophene can be used as intrinsically conductive polymers.

Plastics that are not intrinsically electrically conductive can be made conductive through the inclusion of electrically conductive additives. Suitable additives include, for example, carbon black, graphite, graphene, metal particles and carbon nanotubes. The plastics that are not intrinsically electrically conductive include polymers with a primary chain consisting exclusively of carbon such as, for example, polyethylene (“PE”) and polypropylene, as well as polyamides, polyurethanes, polyesters and silicones.

The electrically conductive plastic can be present in either solid form, a porous form or a foamed form. It can be stiff or flexible, depending on the underlying polymer.

Conductive plastics with a positive temperature coefficient (PTC) of the electrical resistance, which produce an automatic reduction of the current, and thereby of the heat generation, with increasing temperature, are particularly preferred.

The electrical conductivity of the plastic lies between 10² and 10³ S/m, preferably between 10² and 10⁴ S/m.

The electrodes are expediently planar, with the planar electrodes advantageously having a certain degree of mechanical flexibility, thereby enabling a reversible pressing-on and releasing-off via their contact with the heating body's electrically conductive plastic when it is under pressure and pressure is released, respectively. Suitable planar electrodes can be, for example, metal foils, metal-coated polymer foils, metallized wire meshes, metallized meshes or conductive foams that ensure an adequately low electrical supply resistance. The heating body material is an electrically conductive plastic that is preferably in the form of a foil, plate or a conductive foam.

To prevent the flow of current in the unloaded state, electrically non-conductive spacers (4) must be attached with a certain, i.e. defined, spacing from one another at points or in a linear arrangement between the electrodes (2), (3) and the electrically conductive plastic (1) of the heating body, preventing the electrodes (2),(3) from coming into limited, random, local contact with the electrically conductive plastic (1) of the heating body. The magnitude of the current is reduced entirely to zero through the application, according to the invention, of the spacers (4) in the absence of applied pressure. The spacers (4) can be thin, flexible, foam foils or thin textile fibers. It is necessary to ensure here that the surface covered by the spacers (4) is very small, if possible less than 10%, in comparison with the total surface of the heating mat or electrically conductive plastic (1) heating body total area.

### Preferred Forms of Embodiments

In a first heating mat embodiment, the electrically conductive plastic (1) consists of a conductive foam panel, the electrodes (2), (3) of a metal wire mesh, and the spacers (4) of thin polyester fibres that are laid at a distance of several centimetres from one another between the foam panel and the electrodes.

In a second heating mat embodiment, thin foam pads with a lateral extent of a few millimetres are glued as spacers (4) onto the foam panel at a distance of several centimetres from one another.

In a third heating mat embodiment, the electrodes (2), (3) are formed from a metallized mesh. A significant advantage of these electrodes over the metal wire mesh of the first and second forms of embodiment is the greater flexibility and lower weight.

### EXAMPLES

### Example 1

This example shows the principle of operation of the invention. A conductive PE foam (ELS-M) with dimensions of 470×320 mm and a thickness of 6 mm has gauze electrodes of stainless steel applied to both sides. The gauze electrodes consist of stainless steel wires with a mesh width of 1.4 mm, and are fastened loosely to the foam at the edge. PET plastic filaments with a diameter of 0.5 mm spaced about 6 cm apart are woven into the wire mesh as spacers between the lower gauze electrode and the conductive foam. 28 Foam platelets (2 mm thick) are glued about 8 cm apart from one another as spacers between the upper gauze electrode and the conductive foam. In principle, other materials and body shapes can be used as spacers, provided they do not prevent the wide-area contact between the electrodes and the conductive foam when loaded.

If a voltage of 60 V is applied to the electrodes, no measurable current flows through the heating mat in the unloaded case. If the mat is locally loaded, a significantly higher current starts to flow at the locally loaded location. In one example, the loading, determined by the geometry of the applied load, is applied in an annular region with an inner diameter of 3.5 cm and an outer diameter of 6.6 cm. This corresponds to a loaded area of 24.6 cm². If the area is loaded with a mass of 9.4 kg, a current of 140 mA flows. This corresponds to a local current density of 5.7 mA/cm². If the load is increased to 13.3 kg, the current increases to 160 mA, or 6.5 mA/cm². A temperature increase of 30 to 35 K in comparison with the unloaded part of the mat results from this.

In a second variant, the central part of the heating mat is subjected to a weight of 80 kg in the area of a rectangle measuring 31×20 cm. The current density now amounts to 1.3 A, and the local current density to 2.1 mA/cm².

If a person with a weight of about 75 kg now steps onto the mat, a current of 1.34 A flows. Assuming a sole area of about 500 cm², a current density of 2.7 mA/cm² results. The electrical power of 80 W produced in this way leads to fast heating of the mat underneath the feet, wherein a temperature increase of between 15 and 25 degrees, depending on the foot contact, can be demonstrated by means of thermography after about 10 seconds (FIG. 3).

### Comparative Example 2

This example shows the significance of the spacers for the reduction of the idle current in the unloaded case, as a result of spacers not being used. A conductive foam with dimensions of 21×21 cm and a thickness of 7 mm has gauze electrodes of stainless steel attached to both sides. The gauze electrodes consist of stainless steel wires with a mesh width of 1.4 mm, and are fastened loosely to the foam at the edge. There are no spacers. If a voltage of 60 V is applied to the electrodes, then a small but easily measurable current of 10 mA, caused by random, point-like contacts, flows through the heating mat when it is unloaded. If the mat is locally loaded, a higher current, comparable to that in example 1, starts to flow at this location.

### LIST OF REFERENCE SIGNS

1 Conductive plastic
2 Upper electrode
3 Lower electrode
4 Spacer
5 Heating mat

What is claimed is:

1. An electric surface heater comprising an electrically conductive plastic body and an upper and a lower electrode to which an electric voltage is applied, wherein at least one of the two electrodes is flexible, and that between the upper electrode and the plastic body and/or the lower electrode and the plastic body, thin spacers are attached at defined distances from one another, so that no current flows in an unloaded state, but that under a load the flexible electrode sags, and a material-bonded contact to the electrically conductive plastic body develops, thereby realizing a local flow of current and heating.

2. The electric surface heater according to claim 1, wherein the electrically conductive plastic body is intrinsically conductive.

3. The electric surface heater according to claim 2, wherein that the electrically conductive plastic body comprises doped poly-3,4-ethylenedioxythiophene, polyaniline, polypyrrole or polythiophene.

4. The electric surface heater according to claim 1, wherein the electrically conductive plastic body comprises conductive additives.

5. The electric surface heater according to claim 4, wherein the conductive additives are selected from one or more of carbon black, graphite, graphene, metal particles and carbon nanotubes.

6. The electric surface heater according to claim 4, wherein the electrically conductive plastic body is formed from polymer with a primary chain consisting exclusively of carbon.

7. The electric surface heater according to claim 6, wherein the electrically conductive plastic body is formed from polymer selected from polyethylene, polypropylene, polyvinyl fluoride, polyvinylidene fluoride, polyvinyl chloride, polyvinylidene chloride, polyethylene vinyl acetate copolymer, polyamide, polyurethane, polyester or silicone.

8. The electric surface heater according to claim 1, wherein the electrically conductive plastic body is present either in solid form, porous form or foamed form.

9. The electric surface heater according to claim 1, wherein the electrically conductive plastic body has an electrical resistance with a positive temperature coefficient (PTC).

10. The electric surface heater according to claim 1, wherein the electrically conductive plastic body has an electrical conductivity of the plastic of between 10² and 10⁵ S/m.

11. The electric surface heater according to claim 10, wherein the electrical conductivity of the plastic is between 10² and 10⁴ S/m.

12. The electric surface heater according to claim 1, wherein the upper and lower electrode are planar.

13. The electric surface heater according to claim 12, wherein the planar electrodes comprise metal foils, metal-coated polymer foils, metal wire mesh, metallized mesh or conductive foams.

14. The electric surface heater according to claim 1, wherein the spacers are electrically non-conductive and are attached at a certain spacing from one another at points or are in a linear arrangement on the upper and/or lower side of the electrically conductive plastic body.

15. The electric surface heater pacer according to claim 14, wherein the spacer consists of a foam foil or textile fibres, and the spacers cover a surface area that is less than 10% of the electrically conductive plastic body total area.
